(19) United States
(12) Patent Application Publication
(10) Pub. No.: US 2019/0223660 A1
(43) Pub. Date: Jul. 25, 2019

(54) SYSTEM AND METHOD FOR REAL TIME SYNCHRONIZATION OF SET OF INSTRUCTIONS USING IOT DEVICES

(71) Applicant: Connected Cooking Solutions Private Limited, Bangalore (IN)

(72) Inventor: Bahubali SHETE, Bangalore (IN)

(21) Appl. No.: 16/166,577

(22) Filed: Oct. 22, 2018

Related U.S. Application Data
(60) Provisional application No. 62/574,861, filed on Oct. 20, 2017.

(51) Int. Cl. A47J 36/32; G05B 13/02

(52) U.S. Cl. CPC A47J 36/321; G05B 13/0265

(57) ABSTRACT

A system and method for real-time synchronization of set of instructions using IoT (also referred to as connected or smart) devices. The system has a plurality of sensors to measure various cooking parameters such as timer, flame intensity, temperature, pressure, volume or weight. The system has a voice assistant device to interact with the user(s), a mobile application to control the sensors, and a cloud server for storing the recipes, performing computation to identify the parameters for each step in a recipe and sending instructions to the smart devices and the user to execute each of the steps. The system allows user to follow set of instructions for cooking in a prearranged manner, measures the ingredients based on actual number of servings that is being cooked, monitors and calibrates the cooking time, flame intensity automatically based on measured parameters and suggests user(s) to take required actions.

### CLAIM OF PRIORITY

This application claims priority to U.S. Provisional Patent application No. 62/574,861 filed Oct. 20, 2017, the contents of which are incorporated herein by reference in its entirety.

### FIELD OF THE EMBODIMENTS

The present invention relates to a system and method for synchronization of set of instructions through IoT devices for cooking food in kitchen. More particularly, the invention relates to real-time synchronization of set of instructions while cooking using Internet of things (IoT) devices.

### BACKGROUND OF THE EMBODIMENTS

Internet of Things is the concept of connecting any device to the Internet and to other connected devices. The IoT is a network of connected things and people—all of which collect and share data about the way they are used and about the environment around them.

Multiple areas of application of IoT devices are known in the prior art, wherein most of the IoT devices are only used to acquire information. Typically, the existing method collects, stores and provides the sensory information obtained from the IoT devices but lacks in synchronizing with various other systems such as voice recognition, machine learning, natural language processing, artificial intelligence etc.

One domain of interest for IoT technology is kitchen appliances. IoT devices can assist user(s) in performing multiple tasks in the kitchen, from providing cooking assistance to automating cooking and purchase of cooking items. Also, most people refer to recipe manuals, in form of text, video or audio for cooking food. IoT devices could be used to provide assistance while cooking by automating the cooking process by synchronizing connected, smart kitchen appliances in accordance with the recipe. However, current solutions are mostly useful to capture the sensor data from such connected appliances and fail to provide useful assistance to the user(s) while cooking. Hence, there is a need for a solution to provide effective, automated synchronization and operation of cooking appliances in accordance with user(s)'s recipes to automate the task of cooking.

### SUMMARY OF THE EMBODIMENTS

The present invention provides a method and system for real-time synchronization of connected, smart kitchen appliances in form of IoT devices in accordance with the set of instructions in a recipe to provide assisted cooking.

The present application discloses a method of providing real-time synchronization of set of cooking instructions using connected devices with sensors, the method comprising the steps of: receiving request for a recipe from a user; determining cooking parameters required for each step of the recipe; triggering step by step execution of each step in the recipe; measuring and sending data parameters related to cooking at each step in the recipe from the connected devices with sensors; correlating received data parameters with stored steps of cooking in the recipe; monitoring and controlling connected devices with sensors at each step of the recipe in accordance with correlation results; alerting the user(s) upon completion of all steps in the recipe; switching off the connected devices with sensors upon completion all steps in the recipe.

The method of the present application also comprises wherein the request for a recipe is received in form of audio command. The method further comprises implementing machine learning for interpreting the recipe, determine cooking parameters from the recipe and learning from user(s) feedback. The method also comprises wherein the cooking parameters include pressure, temperature, weight, volume, time and flame intensity, wherein the cooking parameters are determined based on the requested recipe and quantity to be cooked, and wherein the cooking parameters are displayed to the user through a mobile application. The method also comprises wherein instructions are provided to the user through a voice enabled communication device.

The present invention comprise a system for providing real-time synchronization of set of cooking instructions using connected devices with sensors, the system comprising: a communication device for receiving a request for a recipe from the user(s); a connected device with sensor for monitoring and measuring cooking parameter related to cooking time; a connected device with sensor for monitoring and measuring cooking parameter related to flame intensity; a connected device with sensor for measuring cooking parameter related to volume; a connected device with sensor for measuring cooking parameter related to weight; a connected device with sensor for measuring cooking parameter related to temperature; a connected device with sensor for measuring cooking parameter related to pressure; a cloud server for determining cooking parameters to be measured, receiving the measured cooking parameters from connected devices with sensors, correlating the measured cooking parameters with set of instruction for the requested recipe, monitoring connected devices with sensors based on the correlation results and sending instructions for operation of the connected devices based on the correlation results; a mobile communication device for receiving and displaying measured parameters values and providing notification upon completion of all steps in the recipe.

The system also comprises wherein the request for a recipe is received in form of audio command. The system further comprises machine learning engine for interpreting the recipe, determine cooking parameters from the recipe and learning from user(s) feedback. The system comprises wherein the cooking parameters include pressure, temperature, weight, volume, time and flame intensity, wherein the cooking parameters are determined based on the requested recipe and quantity to be cooked, and wherein the cooking parameters are displayed to the user through a mobile application. The system comprises a voice enabled communication device provides instructions to the user for cooking and wherein the connected devices with sensors are connected to the cloud server over internet.

### BRIEF DESCRIPTION OF THE EMBODIMENTS

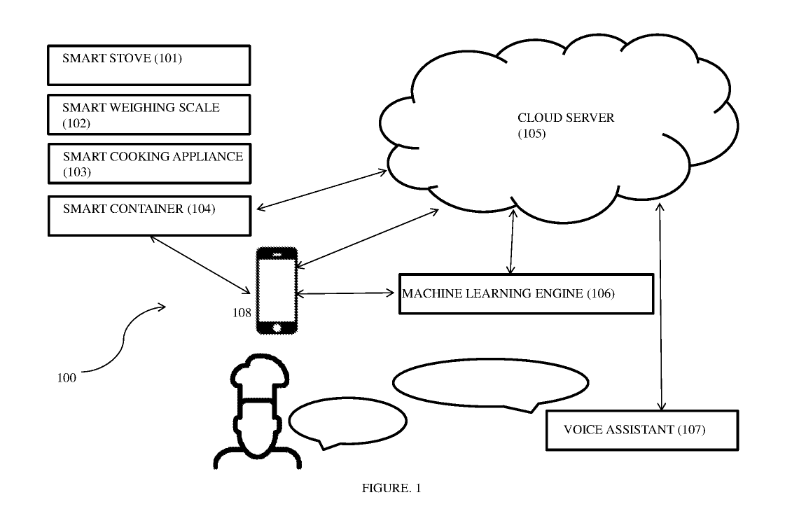

FIG. 1 illustrates a block diagram of the system in accordance with the present invention for real time synchronization of IoT devices in accordance with a recipe.

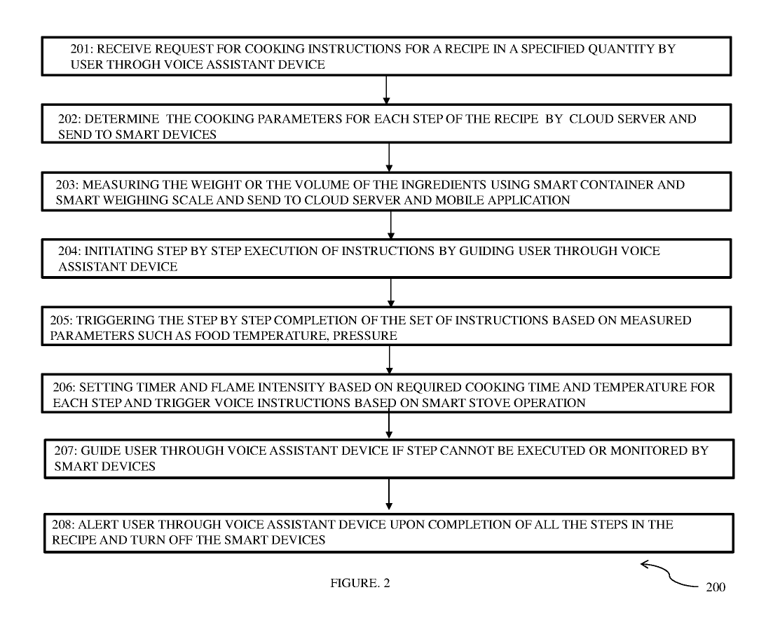

FIG. 2 illustrates a process flow diagram of a method for real time synchronization of IoT devices in accordance with a recipe, in accordance with the present invention.

### DETAILED DESCRIPTION OF THE EMBODIMENTS

Described herein are the methods, computer systems and software for providing real time synchronization of IoT devices in accordance with a recipe. The following detailed description of the invention refers to the accompanying drawings. Various changes and modifications obvious to one skilled in the art to which the invention pertains are deemed to be within the spirit, scope and contemplation of the invention.

The term “IOT device” or “smart device” as claimed in the present invention refers to computing device that connects to a network and has the ability to transmit and receive data over the internet.

The system comprises of a plurality of IOT devices, also referred to as smart devices, to measure various parameters such as timer, flame intensity, temperature, pressure, weight, volume. The present invention further comprises, a voice assistant device to interact with the user(s), a mobile application to control the sensors, and a cloud server for the data storage and computation. The present invention allows the user(s) to follow the set of instructions for cooking in a prearranged manner and measures the ingredients based on the recipe and number of servings to be cooked.

The present invention provides the system which helps the user(s) to execute the instructions in recipe step-by-step in a voice interactive way. The system is activated through the sensors which are mounted on various appliances/devices in kitchen. The sensors collect various parameters such as time of cooking, temperature of food, quantity/weight of ingredients etc. In case the IOT devices are unable to monitor the parameters, the user(s) is guided through the voice enabled assistant device by providing verbal, interactive instructions.

The present invention eliminates the need to manually refer to the set of instructions (recipe) for cooking. The present system receives input from the user(s) regarding the recipe and servings to be cooked, identifies the step-by-step instructions for following the recipe, synchronizes and controls the smart kitchen appliances based on data received from the sensors, guides the user(s) to perform actions in real time based on the collected sensors data and monitors and calibrates the cooking time automatically in accordance with the recipe. The user(s) does not need to manually operate the kitchen appliances and set the timers for following the recipe and only needs to follow the real time instructions provided after selecting the recipe. The invention assists the user in the process of cooking real time based on data collected from the sensors to execute the recipe in a more accurate yet easier manner.

The present invention could use multiple sensors in the kitchen appliances for specific functions to be performed, including but not limited to measuring time, flame intensity, temperature, volume of a liquid ingredient, weight of cooking ingredients and cooking pressure. These sensors could be embedded in multiple kitchen appliances or devices to measure these parameters.

FIG. 1 illustrates the block diagrams of a system 100 in accordance with an embodiment of the invention. As part of the embodiment, the smart stove (101) is enabled with a timer and a sensor such as temperature probe to measure flame intensity. Further, temperature probe is used as a sensor in a smart cooking appliance (102) for measuring the temperature and/or pressure during cooking. A sensor is used in a smart container (104) to measure the quantity/volume of liquid ingredients. Also, smart weighing scale (103) is used to weight the ingredients. The devices 101, 102, 103, 104 are connected to the cloud server through internet and transmit the measured parameters in real time. The system is further enabled with a voice assistant device (107) that interacts with the user(s) through voice communication to receive inputs and to provide real-time instructions to the user(s). The system also comprises a mobile application (108) that the user installs on his/her mobile communication device. The mobile application (108) enables user(s) to control the sensors and display various measurement parameters to the user(s) in real time. The mobile application (108) enables user(s) to activate/deactivate the smart/IoT devices, enable/disable their connection to the cloud through internet, and provide user input and to provide updates to the user(s) regarding the operation or cooking events from the smart devices. The system uses a cloud server (105) enabled with a machine learning engine (106) to store the recipes, receive user inputs through the voice assistant device (107), identify the requested recipe, determine the ingredients and step-by-step instructions depending on the quantity requested by the user(s), receive and store the measurement parameters from all the sensors, provide real time guidance to the user(s) during cooking based on the received measurement parameters and perform real time synchronization of the smart cooking appliances based on the instructions to be followed.

In one of the embodiments of the invention, a machine learning engine (106) is used to interpret instructions cited in the recipe(s), determine parameters such as ingredients required, cooking time, temperature and pressure for cooking, flame intensity, volume of liquid ingredients, weight of solid ingredients, synchronization process to conduct real time operation of the kitchen appliances for performing the steps in accordance with the selected recipe. It also learns user behavior based on the user history stored in the cloud server (105) and calibrates the cooking instructions automatically. Also, the machine learning engine (106) receives user input and feedback to further improve the system's performance.

In another embodiment of the invention, when the smart devices such as smart stove (101), smart weighing scale (102), smart cooking appliance (103) and smart container (104) are turned ON, the present system prompts the user(s) to interact through the mobile application (108) or voice assistant(107) and asks the recipe to be cooked based on user(s) input. The system then determines parameters such as cooking time, temperature, pressure, volume and weight of ingredients automatically and guides the user(s) to use the smart devices in a synchronized manner to collect parameters and determine actions for each step in the recipe. Once all the identified steps for the recipe are completed, the system alerts the user(s) through the voice assistant device (107) and/or through the mobile application (108).

In the preferred embodiment of the present invention, the smart stove (101) is enabled with a knob that may be used as timer and also as the flame intensity controller, which can be operated independently.

In the preferred embodiment of the present invention, the smart cooking appliance (103) is a temperature probe that is placed in the food being cooked. The temperature measurement transducer is wired with a long wire and is connected to the internet.

In another embodiment of the present invention, the smart cooking appliance (103) is an electric oven enabled with temperature sensor and is connected to the internet.

In the preferred embodiment of the present invention, the smart container (104) and the smart weighting scale (102) are standalone devices that get connected through the mobile application (108) or directly to the internet. The mobile application could be installed from a third party engine.

In the preferred embodiment of the present invention, the smart devices (101), (102), (103), (104) may be connected to the internet directly or through a gateway.

FIG. 2 illustrates a process flow of a method for controlling the smart devices (101), (102), (103), (104) in accordance with an embodiment of the invention. The method 200 starts with the step 201, wherein the user(s) interacts with a voice assistant (107) to request cooking instructions for a recipe along with the quantity or servings to be cooked. At step 202, the cooking parameters for each step of the recipe are determined by the cloud server (105) and sent to the respective smart devices (101), (102), (103), (104). At step 203, weight or the volume of the ingredients is measured automatically using smart container (104) and smart weighing scale (102) in accordance with the required quantity and the measured values are send to cloud server (105) and mobile application (108). At step 204, step by step execution of instructions is initiated by guiding user(s) through voice assistant device (107). At step 205, step by step completion of the set of instructions is triggered based on measured parameters such as food temperature, pressure using the smart cooking appliance (103). At step 206, timer and flame intensity is set through the smart stove (101) based on required cooking time and temperature for each step and voice instructions are triggered based on smart stove (101) operation. At step 201, the user is guided through voice assistant device (107) if step cannot be executed or monitored by smart devices (101), (102), (103) or (104). At step 208, the user is alerted upon completion of all the steps in the recipe and the smart devices (101), (102), (103) or (104) are turned off.

In the present invention the measurement of performance of rule helps in understanding the user's preference and fine-tuning the rule accordingly. The present system eliminates the low performing rules and retains the rules which are performing well. The present system understands the effectiveness of the rules and more relevant content is provided to the user. Therefore, the user(s) engagement is increased.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more 10 elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

The embodiments in accordance with the present invention can be implemented with any combination of hardware and software. If implemented as a computer implemented apparatus, the present invention can be implemented using means for performing all of the steps and functions described above.

Although the description above illustrates the present invention with many specific examples, these should not be construed as limiting the scope of the invention buy merely as illustrating some of the presently preferred embodiments of this invention. Thus, the scope of the invention should be determined by the appended claims and any and all equivalents thereof, rather than the examples given. It should be understood that various changes and substitutions could be made herein without departing from the spirit and scope of the invention.

What is claimed is:

1. A method of providing real-time synchronization of set of cooking instructions using connected devices with sensors, the method comprising the steps of:
receiving a request for a recipe from a user;
determining cooking parameters required for each step of the recipe;
triggering a step by step execution of each step in the recipe;
measuring and sending data parameters related to cooking at each step in the recipe from the connected devices with sensors;
correlating received data parameters with stored steps of cooking in the recipe;
monitoring and controlling connected devices with sensors at each step of the recipe in accordance with correlation results;
alerting the user(s) upon completion of all steps in the recipe;
switching off the connected devices with sensors upon completion all steps in the recipe.

2. A method of claim 1, wherein the request for the recipe is received in form of an audio command.

3. A method of claim 1, further comprising implementing machine learning for interpreting the recipe, determining the cooking parameters from the recipe and learning from user(s) feedback.

4. A method of claim 1, wherein the cooking parameters include pressure, temperature, weight, volume, time and flame intensity.

5. A method of claim 1, wherein the cooking parameters are determined based on the requested recipe and quantity to be cooked.

6. A method of claim 1, wherein the cooking parameters are displayed to the user through a mobile application.

7. A method of claim 1 wherein instructions are provided to the user through a voice enabled communication device.

8. A system for providing real-time synchronization of set of cooking instructions using connected devices with sensors, the system comprising:
a communication device for receiving a request for a recipe from a user(s);
a connected device with sensor for monitoring and measuring cooking parameter related to cooking time;
a connected device with sensor for monitoring and measuring cooking parameter related to flame intensity;
a connected device with sensor for measuring cooking parameter related to volume;
a connected device with sensor for measuring cooking parameter related to weight;
a connected device with sensor for measuring cooking parameter related to temperature;
a connected device with sensor for measuring cooking parameter related to pressure;
a cloud server for determining cooking parameters to be measured, receiving the measured cooking parameters from connected devices with sensors, correlating the measured cooking parameters with set of instruction for the requested recipe, monitoring connected devices with sensors based on the correlation results and sending instructions for operation of the connected devices based on the correlation results;
a mobile communication device for receiving and displaying measured parameters values and providing notification upon completion of all steps in the recipe.

9. The system in accordance with claim 8, wherein the request for the recipe is received in form of an audio command.

10. The system in accordance with claim 8, further comprising machine learning engine for interpreting the recipe, determining the cooking parameters from the recipe and learning from user(s) feedback.

11. The system in accordance with claim 8, wherein the cooking parameters include pressure, temperature, weight, volume, time and flame intensity.

12. The system in accordance with claim 8, wherein the cooking parameters are determined based on the requested recipe and quantity to be cooked.

13. The system in accordance with claim 8, wherein the cooking parameters are displayed to the user through a mobile application.

14. The system in accordance with claim 8, wherein a voice enabled communication device provides instructions to the user for cooking.

15. The system in accordance with claim 8, wherein the connected devices with sensors are connected to the cloud server over internet.
